(19) United States
(12) Patent Application Publication
(10) Pub. No.: US 2020/0052885 A1
(43) Pub. Date: Feb. 13, 2020

(54) FILE STORAGE METHOD AND APPARATUS FOR BLOCKCHAIN NETWORK

(71) Applicant: SPACEBOOK TECHNOLOGY CO. LIMITED, Road Town (VG)

(72) Inventors: DAXIN ZHU, SHENZHEN (CN); YU WANG, SHENZHEN (CN)

(21) Appl. No.: 16/244,027

(22) Filed: Jan. 9, 2019

(30) Foreign Application Priority Data
Aug. 9, 2018 (CN) 201810902977.0

(51) Int. Cl. H04L 9/06; G06F 16/13; G06F 21/60; G06F 11/14

(52) U.S. Cl. CPC H04L 9/0637; G06F 16/137; H04L 9/0643; G06F 2201/84; G06F 11/1458; H04L 2209/38; G06F 21/602

(57) ABSTRACT

A file storage method and a file storage apparatus ate provided. The file storage method includes: S1, partitioning an input file into multiple file blocks; S2, establishing a corresponding relationship between index values of multiple storage nodes and identifications of the multiple storage nodes; S3, performing a Hash operation on one of the multiple file blocks and obtaining a first identification according to a result of the Hash operation and the corresponding relationship; and S4, storing the one of the multiple file blocks on a first storage node corresponding to the first identification. Therefore, a method for assigning the storage node based on a Hash value is provided, and because the Hash value of each file block is fixed and unchangeable, so that for a submitted file, a corresponding storage relationship can be easily queried, thereby avoiding cheating on scheduling.

### FIELD OF THE DISCLOSURE

The disclosure relates to the field of blockchain technologies, and more particularly to a file storage method and a file storage apparatus for a blockchain network.

### BACKGROUND

Storage methods of conventional blockchain systems are classified into two types. One is a centralized storage method, such method would take up a large amount of IDC (Internet Data Center) resources for storage, hut because not all files are frequently accessed, and the amount of popular accessed files is actually not high, so that there are a lot of high-performance and high-quality storage spaces that store low-efficiency files. The other one is a distributed P2P storage method, such method is inexpensive, but its sharing speed is slow, and most of hosts are personal nodes, and therefore the throughput performance is poor.

Regarding an existing file storage method, at the aspect of file allocation, a file is allocated based upon machine performance and storage space by a central system as per a certain formula, and thus there is unfairness. Accordingly, for the blockchain system, it is necessary to provide a file storage method which is able to handle every business fairly without being affected by other means and further can be simply verified whether it is fair and reasonable.

### SUMMARY

In view of the above issues in the related art, the disclosure provides a file storage method and a file storage apparatus for a blockchain network.

Technical solutions of the disclosure are embodied as follows.

According to an aspect of the disclosure, a file storage method for a blockchain network, includes:

S1, partitioning an input file into a plurality of file blocks;

S2, establishing a corresponding relationship between index values of a plurality of storage nodes and identifications of the plurality of storage nodes;

S3, performing a Hash operation on one of the plurality of file blocks, and obtaining a first identification according to a result of the Hash operation and the corresponding relationship, and

S4, storing the one of the plurality of file blocks onto a first storage node corresponding to the first identification.

According to an embodiment of the disclosure, performing a Hash operation on one of the plurality of file blocks includes: performing a secure Hash algorithm 1 (SHA-1) operation on the one of the plurality of file blocks.

According to an embodiment of the disclosure, the step S3 includes: adding multiple results of the SHA-1 operation to obtain a value Mi; calculating K=Mi mod MaxPP, where MaxPP represents an amount of the plurality of storage nodes, and using the K as an index value to search the first identification from the corresponding relationship.

According to an embodiment of the disclosure, the file storage method further includes: before the step S2, setting the index values of the plurality of storage nodes according to respective times of the plurality of storage nodes joining the blockchain network.

According to an embodiment of the disclosure, the file storage method further includes: after the step S4, obtaining a second identification(s) according to the result of the Hash operation and the corresponding relationship, and storing backup data of the one of the plurality of file blocks to a second storage node(s) corresponding to the second identification(s).

According to an embodiment of the disclosure, the file storage method concretely includes: getting Kj=(K+j) mod MaxPP, where j is an integer greater than or equal to 1 and smaller than or equal to MaxPP; using Kj as an index value to obtain the second identification from the corresponding relationship; and storing j number(s) of backup data to j number(s) of second storage node(s) respectively, wherein an identification(s) of the j number(s) of second storage node(s) is/are an identification(s) obtained by using K1 to Kj as the index value(s).

According to an embodiment of the disclosure, the file storage method further includes: after the step S4, S5, dispatching all file blocks of a stored file to network host nodes for storage when a last accessed time of the stored file on the plurality of storage nodes exceeds a predetermined value.

According to an embodiment of the disclosure, the step S5 includes: obtaining the all file blocks of the stored file: establishing a second corresponding relationship between index values of a plurality of network host nodes mid identifications of the plurality of network host nodes; performing a second Hash operation on one of the obtained all file blocks, and obtaining a third identification according to a result of the second Hash operation and the second corresponding relationship; and storing the one of the obtained all file blocks to a network host node corresponding to the third identification.

According to an embodiment of the disclosure, the file storage method further includes, after the step S5, obtaining a fourth identification(s) according to the result of the second Hash operation and the second corresponding relationship; and storing backup data of the one of the obtained all file blocks to a network host node(s) corresponding to the fourth identification(s).

According to another aspect of the disclosure, a file storage apparatus for a blockchain network, includes: one or more processors, and a memory coupled to the one or more processor and stored with a plurality of modules executable by the one or more processors. The plurality of modules includes: a partitioning module, configured to partition an input file into a plurality of file blocks; a relationship establishing module, configured to establish a corresponding relationship between index values of a plurality of storage nodes and identifications of the plurality of storage nodes; a Hash operation module, configured to perform a Hash operation on one of the plurality of file blocks and obtain a first identification according to a result of the Hash operation and the corresponding relationship, and a storing module, configured to store the one of the plurality of file blocks to a first storage node corresponding to the first identification.

According to still another aspect of the disclosure, a file storage apparatus for a blockchain network, includes: one or more processors, and one or more memories coupled to the one or more processors, the one or more memories storing program instructions for causing, when executed, the one or more processors to perform any one of the file storage methods of the above embodiments.

Sum up, the above technical solutions of the disclosure propose a method for assigning the storage node based on a Hash value, and because the Hash value of each file block is fixed and unchangeable, so that for a submitted file, a corresponding storage relationship can be easily queried, thereby avoiding cheating on scheduling.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts.

FIG. 1 is a flowchart of a file storage method for a blockchain network according to an embodiment of the disclosure.

FIG. 2 is a structural view of a blockchain network according to an embodiment of the disclosure.

FIG. 3 is a flowchart of a file storage method for a blockchain network according to another embodiment of the disclosure.

FIG. 4 is a flowchart of a file storage method for a blockchain network according to still another embodiment of the disclosure.

### DETAILED DESCRIPTION OF EMBODIMENTS

Technical solutions of embodiments of the disclosure will be clearly and fully described in the following with reference to the accompanying drawings in the embodiments of the disclosure. Apparently, the described embodiments are some of the embodiments of the disclosure, but not all of the embodiments. All other embodiments obtained by skilled person in the art based on the described embodiments of the disclosure are within the scope of protection of the instant application.

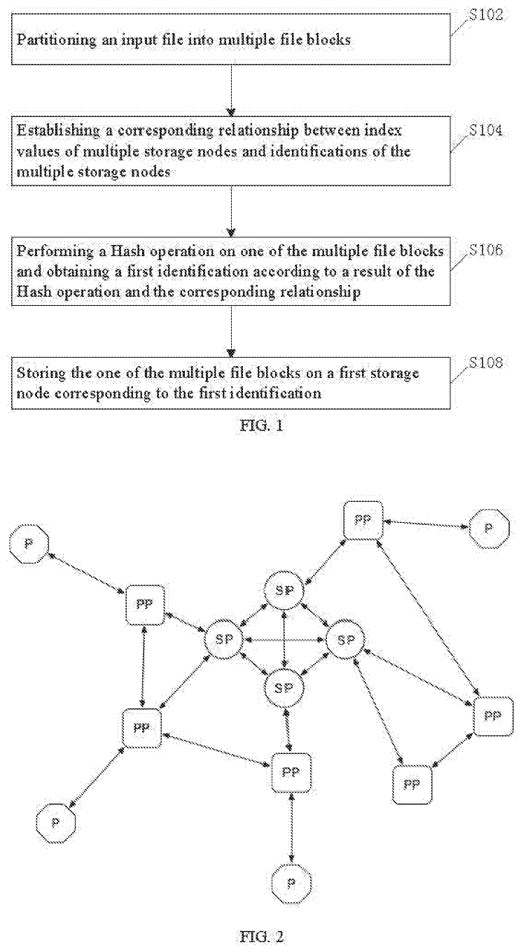

Referring to FIG. 1, an embodiment of the disclosure provides a file storage method for a blockchain network. In particular, the file storage method includes:

step S102, partitioning an input file into multiple (i.e., more than one) file blocks;

step S104, establishing an corresponding relationship between index values of multiple storage nodes and identifications (id) of the multiple storage nodes;

step S106, performing a Hash operation on one of the multiple file blocks and obtaining a first identification according to a result of the Hash operation and the corresponding relationship; and

step S108, storing the one of the multiple file blocks to a first storage node corresponding to the first identification.

The above technical solution of the disclosure provides a method of assigning storage nodes according to Hash values. Because the Hash value of each file block is fixed and unchangeable, as to a submitted file, the corresponding storage relationship can be easily queried, thereby avoiding cheating on scheduling.

FIG. 2 illustrates an exemplary embodiment of a blockchain network. The blockchain network includes: management nodes SP and multiple storage nodes PP in communication with the management nodes SP. The storage nodes PP are in communication with multiple network host nodes P. Functions of the management nodes SP include task scheduling, address mapping of data reading, full synchronization of state information of storage nodes PP in the management node SP, and storing and backing up data store index relationship information in a cluster of multiple SP nodes. Functions of the storage nodes PP include: executing data storage tasks, providing stable and fast data access acceleration services, assigning data storage tasks to the network host node P, and managing multiple network host nodes P connected therewith. Functions of the network host nodes P include: providing data access and upstream bandwidth traffic sharing.

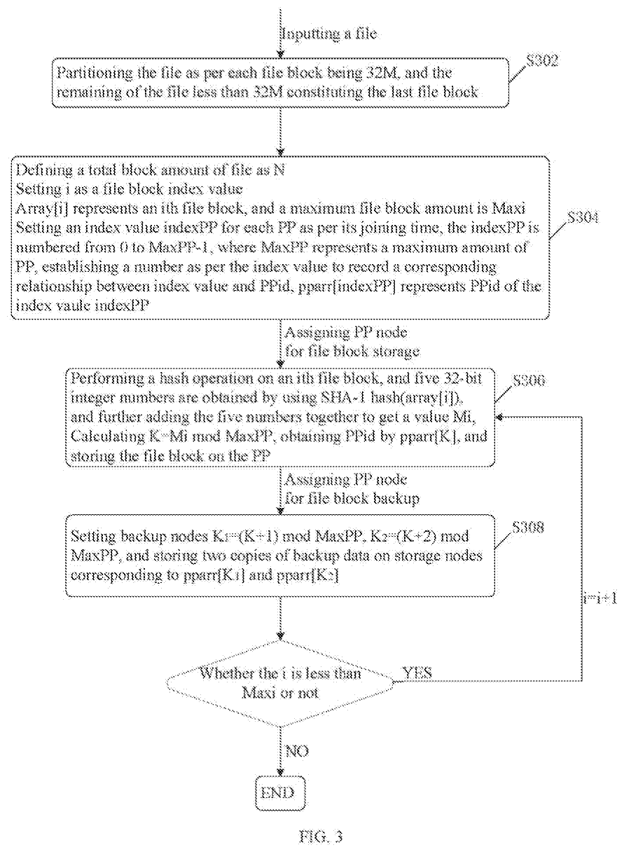

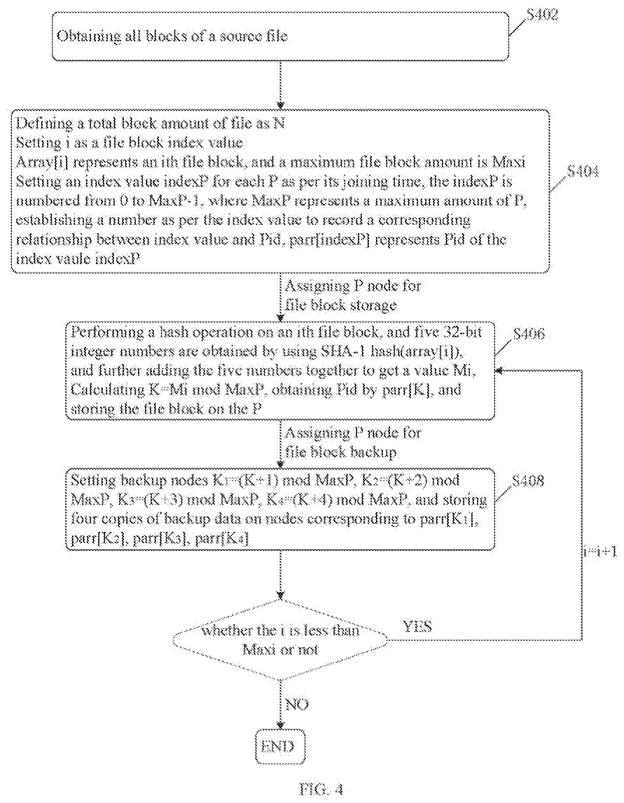

The file storage method for a blockchain network of the disclosure will be described below in detail with reference to FIG. 2. It should be under stood that, in other embodiment, the file storage method according to the illustrated embodiments of the disclosure can also be applied to blockchain networks of other architectures. An additional step(s) may be provided before, among and/or after steps described in FIG. 3 and FIG. 4; or some of the described steps may be replaced or removed for different embodiments.

FIG. 3 is a flowchart showing file partitioning and file allocating. In conjunction with FIG. 2 and FIG. 3, the management node SP is responsible for scheduling of file partitioning. The management node SP assigns each storage node PP with a fixed identification (id), for example, the identification may be formed by five 4-byte integer numbers.

In the step S302, an input file is partitioned. Exemplarily, the input file is partitioned as per the size of each file block being 32 M, and the remaining of the file less than 32 M is used as the last file block.

In addition, before the step S304, an index value may be set for each storage node according to a time of the storage node joining the blockchain network. In particular, for a newly added storage node PP, it is sorted/numbered as per a time joining the network, and the index value of each storage node PP is set as per the sorted serial number. For example, the index value of the first joined storage node PP is 0, the index value of the second joined storage node PP is 1, and so on. Similarly, for a newly added network host node P, it also is sorted as per a time joining the network, and the index value of each network host node P is set according to the sorted serial number. For example, the index value of the first joined network host node P is 0, the index value of the second joined network host node P is 1, and so on. In other embodiment, according to actual needs, the index value of each storage node PP and the index value of each network host node P may also be set in other suitable manners.

In the step S304, a corresponding relationship between index values of multiple storage nodes and identifications of multiple storage nodes is established. Specifically, a total amount of multiple file blocks obtained alter the file partitioning is defined as N, i is set as an index value of file block and i=0, . . . , N−1. Assuming that array[i] represents an ith file block, and Maxi represents the maximum file block amount. Each storage node PP is set with an index value indexPP as per its joining time, and the index value indexPP is numbered from 0 to (MaxPP−1), where MaxPP represents the maximum storage node PP amount. A number is established according to the index value to record the corresponding relationship between the index value and PPid, and pparr[indexPP] represents PPid of the index value indexPP, and PPid represents the identification of the storage node PP.

In the step S306, the ith file blocks is performed with a Hash operation, and in the illustrated embodiment. SHA-1 hash(array[i]) is used, thereby obtaining five 32-bit integer numbers, and the five numbers are added together to obtain a value Mi. Then, it is calculated that K=Mi mod MaxPP, i.e., K is the remainder of Mi divided by MaxPP. Afterwards, PPid is obtained by pparr[K], and the ith file block is stored onto the storage node PP corresponding to the PPid.

In the step S308, backup data of the file block are stored. Specifically, it is calculated that Kⱼ=(K+j) mod MaxPP, where j is an integer greater than or equal to 1 and less than or equal to MaxPP. Then, Kⱼ is used as an index value to obtain a second identification from the corresponding relationship, j copy/copies of backup data is/are stored onto j number(s) of second storage node(s), and the identification(s) of the j number(s) of second storage node(s) is/are an identification(s) obtained by using K₁ to Kⱼ as the index value(s).

In the embodiment associated with FIG. 3, the value of j exemplarily is 2, K₁=(K+1) mod MaxPP, K₂=(K+2) mod MaxPP, two copies of backup data are stored onto the storage nodes PP corresponding to pparr[K1] and pparr[K2] respectively.

In an embodiment, the file storage method of the disclosure further includes: when a last accessed time of a stored file on multiple storage nodes exceeds a predetermined value, dispatching all file blocks of the stored file to network host nodes for storage. For example, for a file stored on multiple storage nodes PP, the management node SP will scan a file list stored in the storage node PP at a certain time interval so as to query the last accessed time of file, if the last accessed time of a file for example is greater than three months, the file block of the file originally stored on the storage node PP is dispatched to a network host node P for storage. Such file management method may be called as a hot and cold management method. In particular, the management node SP may use the method as illustrated in FIG. 4, and the file blocks of the file originally stored on the storage nodes PP are dispatched to network host nodes P for storage.

As illustrated in FIG. 4, in the step S402, for a source file whose last accessed time exceeds a predetermined value, all file blocks of the source file are obtained.

In addition, before the step S404, identifications and index values for multiple network host nodes P may be set. A method of setting identifications and index values for multiple network host nodes P is similar to the method of setting the identifications and the index values for the storage nodes PP, and thus will not be repeated herein.

In the step S404, a corresponding relationship between index values of multiple network host nodes P and identifications of multiple network host nodes P is established. A method for establishing the corresponding relationship may be similar to the method described in the step S304. Specifically, a total amount of multiple file blocks after file partitioning is defined as N, i is set as an index value of the file block and i=0, . . . , N−1. Assuming that array[i] represents an ith file block, and Maxi represents the maximum file block amount. Bach network host node P is set with an index value indexP as per its joining time, the index value indexP is numbered from 0 to (MaxP−1), where MaxP represents the maximum amount of network host node P. A number is built according to the index value to record a corresponding relationship between the index value and Pid. parr[indexP] represents Pid of the index value indexP, and Pid represents the identification of the network host node P.

In the step S406, the ith file block is performed with a Hash operation, and in this embodiment, the SHA-1 hash(array[i]) is used and thereby obtaining five 32-bit integer numbers, and the five numbers me added together to obtain a value Mi. Then, it is calculated that K=Mi Mod MaxP. Pid is obtained by parr[k], and the file block is stored on a network host node P corresponding to the Pid.

In the step S408, it is similar to the step of storing backup data of the file block on the storage node(s) PP. Exemplarily, K₁=(K+1) mod MaxP, K₂=(K+2) mod MaxP, K₃=(K=3) mod MaxP, K₄=(K+4) mod MaxP, and four copies of backup data are stored on network host nodes P respectively corresponding to parr[K₁], parr[K₂], parr[K₃] and parr[K₄].

According to an embodiment of the disclosure, a file storage apparatus for a blockchain network is provided. The file storage apparatus includes:

a partitioning module, configured (i.e., structured and arranged) to partition an input, file into multiple file block;

a relationship establishing module, configured to establish a corresponding relationship between index values of multiple storage nodes and identifications of multiple storage nodes,

a hash operation module, configured to perform a Hash operation on one of the multiple file blocks and obtain a first identification according to a result of the Hash operation and the corresponding relationship; and

a storing module, configured to store the one of the multiple file blocks on a first storage node corresponding to the first identification.

More specifically, the partitioning module, the relationship establishing module, the hash operation module and the storing module may be software modules stored in a memory and executable by one or more processors. In this situation, the file storage apparatus may includes a memory stored with the software modules and one or more processors coupled to the memory. In other words, the file storage apparatus may include one or more processors, and one or more memories coupled to the one or more processors; the one or more memories storing program instructions for causing, when executed, the one or more processors to perform the above described file storage method.

In an embodiment, the Hash operation performed on the one of the multiple file blocks is a secure Hash algorithm 1 (SHA-1) operation.

In an embodiment, the hash operation module includes: a first operation sub-module configured to add multiple results of the SHA-1 operation to obtain a value Mi; a second operation sub-module configured to calculate K=Mi mod Maxpp, where MaxPP represents an amount of the multiple storage nodes; and a third operation sub-module configured to use the K as an index value to obtain the first identification from the corresponding relationship.

In an embodiment, the file storage apparatus further includes a setting module, configured to set the index values of the multiple storage nixies as per times of the multiple storage nodes joining the blockchain network.

In an embodiment, the file storage apparatus further includes: a backing up module, configured to obtain a second identification(s) according to the result of the Hash operation and the corresponding relationship, and store backup data of the one of the multiple file blocks onto a second storage node(s) corresponding to the second identification(s).

In an embodiment, it is calculated that Kⱼ=(K+j) mod MaxPP, where j is an integer greater titan or equal to 1 and less titan or equal to MaxPR. Kⱼ is used as an index value to obtain the second identification(s) from the corresponding relationship, and j copy/copies of backup data is/are stored on j number(s) of second storage node(s), where the identification(s) of the j number(s) of second storage node(s) are an identification(s) obtained by using K₁ to Kⱼ as the index value(s).

In an embodiment, the file storage apparatus further includes: a hot and cold management module, configured to dispatch all file blocks of a stored file to network host nodes for storage when a last accessed time of the stored file on the multiple storage nodes exceeds a predetermined value.

In an embodiment, the hot and cold management module includes:

an obtaining sub-module, configured to obtain the all file blocks of the stored file;

a relationship establishing sub-module, configured to establish a second corresponding relationship between index values of multiple network host nodes and identifications of the multiple network host nodes;

a Hash operation sub-module, configured to perform a second Hash operation on one of the all file blocks and obtain a third identification according to a result of the second Hash operation and the second corresponding relationship; and

a storing sub-module, configured to store the one of the all file blocks onto a network host node corresponding to the third identification.

In an embodiment, the hot and cold management module is further configured to obtain a fourth identification(s) according to the result of the second Hash operation and the second corresponding relationship, and store backup data of the one of the all file blocks on a network host node(s) corresponding to the fourth identification(s).

The foregoing are only illustrated embodiments of the disclosure and not intended to limit the disclosure. Any modifications, equivalent substitutions, improvements, etc., made within the spirit and scope of the disclosure, should be included in the protection scope of the application.

What is claimed is:

1. A file storage method for a blockchain network, comprising:
S1, partitioning an input file into a plurality of file blocks;
S2, establishing a corresponding relationship between index values of a plurality of storage nodes and identifications of the plurality of storage nodes;
S3, performing a Hash operation on one of the plurality of file blocks, and obtaining a first identification according to a result of the Hash operation and the corresponding relationship;
S4, storing the one of the plurality of file blocks onto a first storage node corresponding to the first identification.

2. The file storage method as claimed in claim 1, wherein performing a Hash operation on one of the plurality of file blocks comprises;
performing a secure Hash algorithm 1 (SHA-1) operation on the one of the plurality of file blocks.

3. The file storage method as claimed in claim 2, wherein the step S3 comprises:
adding multiple results of the SHA-1 operation to obtain a value Mi:
calculating K=Mi mod MaxPP, where MaxPP represents an amount, of the plurality of storage nodes;
using the K as an index value to search the first identification from the corresponding relationship.

4. The file storage method as claimed in claim 1, before the step S2, further comprising:
setting the index values of the plurality of storage nodes according to respective times of the plurality of storage nodes joining the blockchain network.

5. The file storage method as claimed in claim 3, after the step S4, further comprising:
obtaining a second identification(s) according to the result of the Hash operation and the corresponding relationship;
storing backup data of the one of the plurality of file blocks to a second storage node(s) corresponding to the second identification(s),

6. The file storage method as claimed in claim 5,
getting Kⱼ=(K+j) mod MaxPP, where j is an integer greater than or equal to 1 and smaller than or equal to MaxPP;
using Kⱼ as an index value to obtain the second identification from the corresponding relationship;
storing j number(s) of backup data to j number(s) of second storage node(s) respectively, wherein an identification(s) of the j number(s) of second storage node(s) is/are an identification(s) obtained by using K₁ to Kⱼ as the index value(s).

7. The file storage method as claimed in claim 1, after the step S4 further comprising;
S5, dispatching all file blocks of a stored file to network host nodes for storage when a last accessed time of the stored file on the plurality of storage nodes exceeds a predetermined value.

8. The file storage method as claimed in claim 7, wherein the step S5 comprises;
obtaining the all file blocks of the stored file;
establishing a second corresponding relationship between index values of a plurality of network host nodes and identifications of the plurality of network host nodes;
performing a second Hash operation on one of the obtained all file blocks, and obtaining a third identification according to a result of the second Hash operation and the second corresponding relationship;
storing the one of the obtained all file blocks to a network host node corresponding to the third identification.

9. The file storage method as claimed in claim 8, after the step S5, further comprising:
obtaining a fourth identification(s) according to the result of the second Hash operation and the second corresponding relationship;
storing backup data of the one of the obtained all file blocks to a network host node(s) corresponding to the fourth identification(s).

10. A file storage apparatus for a blockchain network, comprising: one or more processors, and a memory coupled to the one or more processor and stored with a plurality of modules executable by the one or more processors, wherein the plurality of modules comprises:
a partitioning module, configured to partition an input file into a plurality of file blocks;
a relationship establishing module, configured to establish a corresponding relationship between index values of a plurality of storage nodes and identifications of the plurality of storage nodes;
a Hash operation module, configured to perform a Hash operation on one of the plurality of file blocks and obtain a first identification according to a result of the Hash operation and the corresponding relationship;
a storing module, configured to store the one of the plurality of file blocks to a first storage node corresponding to the first identification.

11. A file storage apparatus for a blockchain network, comprising: one or more processors; and one or more memories coupled to the one or more processors, the one or more memories storing program instructions for causing, when executed, the one or more processors to perform:
S1 partitioning an input file into a plurality of file blocks;
S2, establishing a corresponding relationship between index values of a plurality of storage nodes and identifications of the plurality of storage nodes;
S3, performing a Hash operation on one of the plurality of file blocks, and obtaining a first identification according to a result of the Hash operation and the corresponding relationship;
S4, storing the one of the plurality of file blocks onto a first storage node corresponding to the first identification.

12. The file storage apparatus as claimed in claim 11, wherein the Hash operation is a secure Hash algorithm 1 (SHA-1) operation.

13. The file storage apparatus as claimed in claim 12, wherein the S3 comprises:
adding multiple results of the SHA-1 operation, to obtain a value Mi;
calculating K=Mi mod MaxPP, where MaxPP represents an amount of the plurality of storage nodes;
using the K as an index value to search the first identification from the corresponding relationship.

14. The file storage apparatus as claimed in claim 11, wherein the one or more memories store additional instructions to further perform: before the S2,
setting the index values of the plurality of storage nodes according to respective times of the plurality of storage nodes joining the blockchain network.

15. The file storage apparatus as claimed in claim 13, wherein the one or more memories store second additional instructions to further perform: after the S4,
obtaining a second identification(s) according to the result of the Hash operation and the corresponding relationship;
storing backup data of the one of the plurality of file blocks to a second storage node(s) corresponding to the second identification(s).

16. The file storage apparatus as claimed in claim 15, wherein the one or more memories store the second additional instructions to concretely perform:
getting Kⱼ=(K+j) mod MaxPP, where j is an integer greater than or equal to 1 and smaller than or equal to MaxPP;
using K, as an index value to obtain the second identification from the corresponding relationship;
storing j number(s) of backup data to j number(s) of second storage node(s) respectively, wherein an identification(s) of the j number(s) of second storage node(s) is/are an identification(s) obtained by using K₁ to Kⱼ as the index value(s).

17. The file storage apparatus as claimed in claim 11, wherein the one or more memories store additional instructions to further perform: after the S4,
S5, dispatching all file blocks of a stored file to network host nodes for storage when a last accessed time of the stored file on the plurality of storage nodes exceeds a predetermined value.

18. The file storage apparatus as claimed in claim 17, wherein the S5 comprises:
obtaining the all file blocks of the stored file;
establishing a second corresponding relationship between index values of a plurality of network host nodes and identifications of the plurality of network host nodes;
performing a second Hash operation on one of the obtained all file blocks, and obtaining a third identification according to a result of the second Hash operation and the second corresponding relationship;
storing the one of the obtained all file blocks to a network host node corresponding to the third identification.

19. The file storage apparatus as claimed in claim 18, wherein the one or more memories store additional instructions to further perform: after the S5,
obtaining a fourth identification(s) according to the result of foe second Hash operation and the second corresponding relationship;
storing backup data of the one of the obtained all file blocks to a network host node(s) corresponding to the fourth identification(s).
